(19) United States
(12) Patent Application Publication
(10) Pub. No.: US 2017/0185259 A1
(43) Pub. Date: Jun. 29, 2017

(54) TOUCH DISPLAY DEVICE, TOUCH DISPLAY METHOD AND UNMANNED AERIAL VEHICLE

(71) Applicants: INVENTEC APPLIANCES (PUDONG) CORPORATION, Shanghai (CN); INVENTEC APPLIANCES CORP., New Taipei City (TW)

(72) Inventor: Ying-Hua Chen, New Taipei City (TW)

(21) Appl. No.: 15/071,441

(22) Filed: Mar. 16, 2016

(30) Foreign Application Priority Data
Dec. 23, 2015 (CN) 201510981233.9

(51) Int. Cl. G06F 3/0488; G05D 1/10; B64C 39/02; G05D 1/00; G06F 3/041; G06F 3/0484

(52) U.S. Cl. CPC G06F 3/0488; G06F 3/0412; G06F 3/04845; B64C 39/024; G05D 1/0016; G05D 1/101; B64C 2201/146

(57) ABSTRACT

A touch display device including a user interface and a processor is provided. The user interface is for generating a plurality of touch sensing signals and a plurality of drag signals, wherein each drag signal includes information of a touch start position and a touch end position. The processor is configured to generate a plurality of drag vectors using the drag signals by calculating a relative distance and drag direction from the touch start position to the touch end position, determine if the touch sensing signals and the drag vectors match a predetermined condition, and, based on the determination, perform an application program to generate a virtual object displayable on the user interface and control the virtual object in a pilot mode or a settings mode.

This application claims the benefit of People's Republic of China application Serial No. 201510981233.9, filed Dec. 23, 2015, the disclosure of which is incorporated by reference herein in its entirety.

### TECHNICAL FIELD

The disclosure relates in general to a touch display device, and more particularly to a touch display device, a touch display method and an unmanned aerial vehicle that are easy to operate.

### BACKGROUND

Nowadays, entertainment electronic devices have become very popular in people's entertainment. Currently, the unmanned aerial vehicle (UAV) is normally controlled by using a hand-held remote controller, which needs numerous control keys and the flight of the UAV needs a lot of adjustment parameters, so that the operation of the UAV is very complicated and requires a long period of training for the user to master. For those users who are properly untrained in advance and are not familiar with the operation, they lack the sense of direction may easily lose control of the UAV and cause the UAV to crash. Thus, they may lack of interest and cannot enjoy the flying games.

### SUMMARY

The disclosure is directed to a touch display device, a touch display method and an unmanned aerial vehicle (UAV), which allow user's gesture commands to be inputted through the touch and drag of multiple fingers, such that the user can operate the device to experience flying in a more intuitive manner.

According to one embodiment, a touch display device is provided. The touch display device includes a user interface and a processor. The user interface is for generating a plurality of touch sensing signals and a plurality of drag signals, wherein each drag signal includes information of a touch start position and a touch end position. The processor is configured to generate a plurality of drag vectors using the drag signals by calculating a relative distance and drag direction from the touch start position to the touch end position, determine if the touch sensing signals and the drag vectors match a predetermined condition, and, based on the determination, perform an application program to generate a virtual object displayable on the user interface and control the virtual object in a pilot mode or a settings mode.

According to another embodiment, a touch display method is provided. The method includes following steps. A plurality of touch sensing signals are generated. A plurality of drag signals are generated, wherein each drag signal includes information of a touch start position and a touch end position. A plurality of drag vectors are generated by calculating a relative distance and drag direction from the touch start position to the touch end position. Whether a quantity of the touch sensing signals and the drag vector's magnitude or direction match a predetermined condition is determined, and, based on the determination, a virtual object is controlled in a pilot mode or a settings mode.

According to an alternative embodiment, an unmanned aerial vehicle (UAV) is provided. The UAV is controlled by the touch display device or the touch display method, wherein the control of the virtual object corresponds with the control of the UAV.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flowchart of a touch display method according to an embodiment of the present invention.

FIG. 2 is a tree diagram of a touch display device.

FIGS. 3A˜3F are operation diagrams of the touch display device for executing the flowchart of FIG. 1.

FIG. 4 is a flowchart of a touch display method according to an embodiment of the present invention.

FIG. 5 is a tree diagram according to a touch display device.

FIGS. 6A-6B are operation diagrams of the touch display device for executing the flowchart of FIG. 4.

FIG. 7 is a flowchart of a touch display method according to an embodiment of the present invention.

FIG. 8 is a tree diagram according to a touch display device.

FIGS. 9A-9D are operation diagrams of the touch display device for executing the flowchart of FIG. 7.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below for elaborating the invention. However, the embodiments of the invention are for detailed descriptions only, not for limiting the scope of protection of the invention.

### First Embodiment

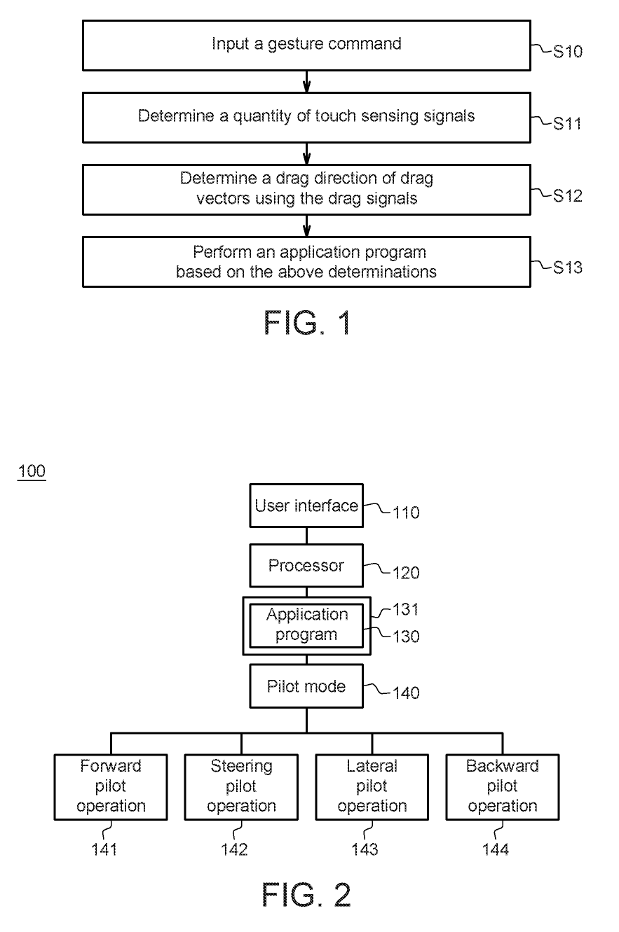

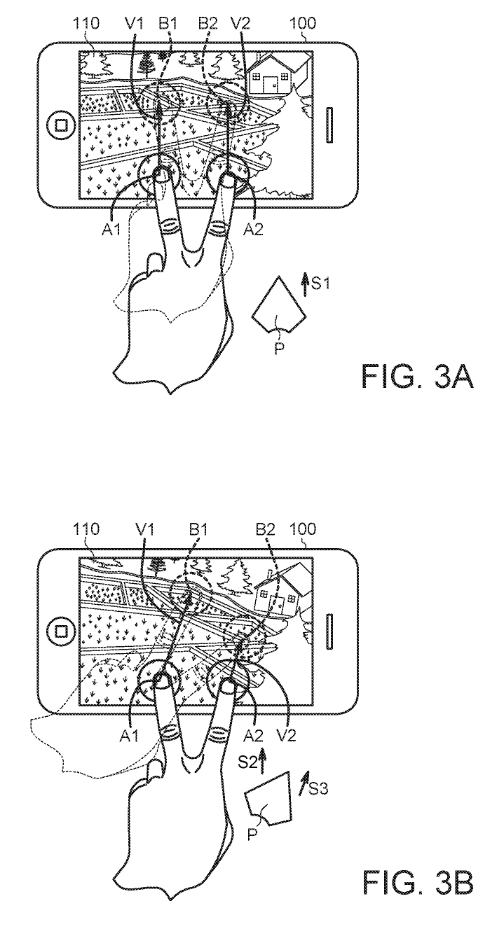

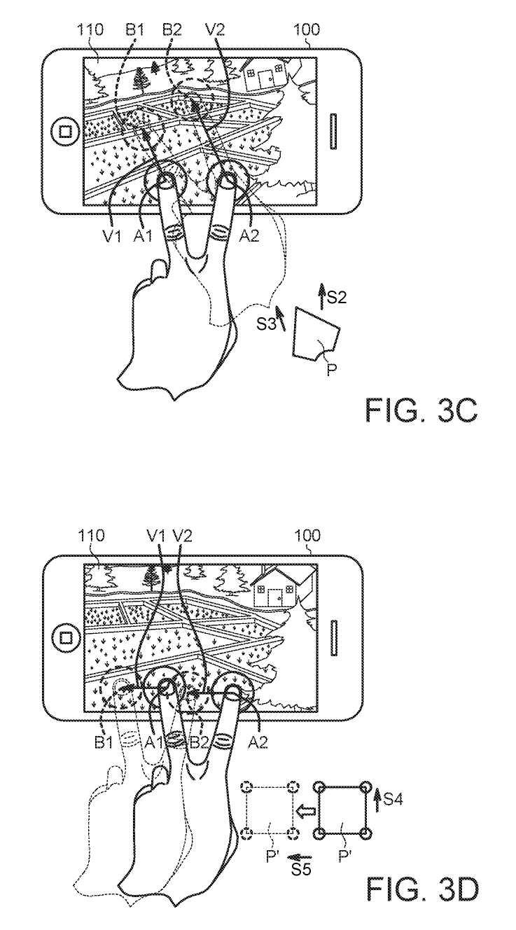

Refer to FIG. 1 to FIGS. 3A˜3F. FIG. 1 is a flowchart of a touch display method according to an embodiment of the present invention. FIG. 2 is a tree diagram of a touch display device 100. FIGS. 3A˜3F are operation diagrams of the touch display device 100 for executing the flowchart of FIG. 1. The touch display method of the present embodiment includes following steps S10˜S13. In step S10, a gesture command is inputted. In step S11, a quantity of touch sensing signals is determined. In step S12, a drag direction of drag vectors using the drag signals is determined. In step S13, an application program is performed based on the above determinations. Apart from the gesture of user's fingers, in the above steps, the user's command can be inputted using other elements such as a writing stylus or induction gloves for touch panel.

Each step of the touch display method of FIG. 1 is exemplified through the simulated flight of UAVs P or P′ as indicated in FIGS. 3A˜3F, but not limited thereto. As indicated in FIGS. 3A˜3F, the user interface 110 of the touch display device 100, such as a capacitive sensing touch display panel, is for sensing a plurality of pressing positions of the user's fingers on the panel and the drag direction of user's fingers. The touch display device 100, which can be a smartphone, a PC tablet or other hand-held electronic devices, has an application program 130 stored in a memory 131 for controlling the flight of the UAV. The touch display device 100 has a processor 120 disposed therein. Based on the gesture command inputted by the user, the application program 130 may perform an operation and control the virtual object in a pilot mode or a settings mode.

In step S10, when the user inputs a gesture command to perform a touch operation, the user interface 110 senses a plurality of pressing positions touched by the user's fingers (to measure a quantity of fingers or form a drag track), a pressing time and a drag direction of fingers to generate a plurality of touch sensing signals and a plurality of drag signals.

As indicated in FIGS. 3A˜3F, the quantity of fingers touching the panel is exemplified by two, and each finger generates a prompt ring on a touching position for recognition. Furthermore, an operation position can be used as a trigger point of an operation if the fingers' pressing time at the same position is larger than a predetermined value. When the fingers move to the touch end positions B1 and B2 from the touch start positions A1 and A2 respectively, the processor 120 can generate a plurality of drag vectors V1 and V2 by calculating a relative distance and a drag direction from the touch start positions A1 and A2 to the touch end positions B1 and B2 for each drag signal. The drag vectors V1 and V2, which indicate relative displacement from a drag start position to a drag end position of the fingers, are directional and can be used for determining the finger drag direction. If the finger drag trace is a straight line, then the touch start position and the touch end position of the drag straight line are determined, and the touch start position and the touch end position are sequentially connected to generate a drag vector and a drag distance of the drag straight line. If the finger drag trace is a leftward drag curve or a rightward drag curve, then the touch start position and the touch end position of the drag curve are determined, and the touch start position and the touch end position are sequentially connected to generate a drag vector and a drag distance of the drag straight line. The touch start positions A1 and A2 of the fingers are used as datum points for calculating the drag distance (drag length) of the drag vectors. If the fingers leave the panel without generating any drag signals, then the drag distance cannot be calculated until the fingers once again press the panel. Then, the touch start positions A1 and A2 newly generated after the fingers once again pressed the panel are used as datum points for calculating the drag distance of the drag vectors.

In step S11, the processor 120 determines whether the quantity of touching fingers matches a predetermined quantity (such as two), and, based on the determination, determines whether the quantity of the touch sensing signals matches a pilot mode 140. Then, in step S12, the processor 120 determines that the drag directions of figures and, based on the determination, determines whether the drag directions or the magnitudes of the drag vectors V1 and V2 match the pilot mode 140. In step S13, if the gesture command inputted by the user matches the two conditions disclosed above, then the processor 120, based on the determination, performs an application program 130 to generate a virtual object (such as the UAV P or P′ or other moveable objects) displayable on the user interface 110 and control the movement of the virtual object.

Refer to FIG. 2, the operation mode 140 includes a forward pilot operation 141, a steering pilot operation 142, a lateral pilot operation 143 and a backward pilot operation 144. If the command inputted by the user corresponds to one of the operation mode 140, then the application program 130 can perform a corresponding flight on a virtual object displayable on the user interface 110 and display an operation information or a function information corresponding to the virtual object on the user interface 110. Examples of the operation information include flight altitude, flight distance, flight time, destination, latitude and longitude. In the specification, the phrase ‘the drag vectors have the same magnitude’ includes ‘the drag vectors have exactly the same magnitude” and ‘the drag vectors have substantially the same magnitude”. The phrase ‘the drag vectors have substantially the same magnitude’ refers to the situation that the drag vectors have a difference within a tolerance such as 0˜1%, 0˜5% or 0˜10%.

Refer to FIG. 3A. When the user's two fingers drag forward at the same time and the drag distances are substantially the same, the processor 120 determines that the quantity of the touch sensing signals matches a determined quantity (such as two) and determines that the drag vectors V1 and V2 have substantially the same magnitudes and point toward a first direction S1, then the pilot mode 140 controls the UAV P or P′ to move in a first direction S1. For example, the processor 120 performs the forward pilot operation 141, such that the UAVs P or P′ can fly forward. Although the drag vectors V1 and V2 may have tiny errors due to manual operation, the UAV can be regarded as performing the forward pilot operation 141 as long as the two drag vectors are still determined as two substantially the same drag vectors. The first direction S1 is orthogonal to a line formed by two initial touch sensing signals. Since the flight direction can be determined according to the nose of aircraft in the pilot mode 140 of the UAV P or P′, various pilot operations can be performed on the UAV P or P′ according to the control methods employed. Selectively, if the direction of the nose of aircraft (for example, the direction of the nose of aircraft points leftward given that the user's front is used as the forward direction) is different from the first direction S1, then the pilot mode 140 can use the first direction S1 as the direction to which the nose of aircraft of the UAV P or P′ points and perform corresponding pilot operations accordingly. Meanwhile, the control information of the UAV P or P′ is provided but the initial direction of the nose of the UAV P or P′ is not corrected. Or, the UAV P or P′ can steer their nose to the first direction S1 and then continue to fly. Or, the UAV P or P′ can directly determine the second to seven directions S2˜S7 according to the first direction S1 without having to be associated with the nose of aircraft. Besides, the forward pilot operation 141 can further determine the flight path of the UAV P or P′ according to the drag track of the user's fingers.

Additionally, when the user's two fingers drag forward at the same time and the drag distance keeps increasing, the processor 120 determines the magnitude of the drag distance, and the pilot mode 140 controls the UAV P or P′ to accelerate. In another embodiment, during the flight task, the processor 120 can determine whether the fingers drag forward along the first direction S1 or drag backward along a direction opposite to the first direction S1, and when the fingers drag forward and then stop, the processor 120 can determine the time required for accelerating the flight according to the length of the fingers' pressing time at the same point. If the fingers release, then the calculation stops. Or, if the fingers do not release but drags backward (with respect to the previous movement) and then stop, then the processor 120 can determine the time required for decelerating the flight according to the length of the fingers' pressing time at the same point. Thus, the pilot mode 140 can control the UAVs P or P′ to accelerate or decelerate according to the above operation.

Refer to FIG. 3B. When the user's two fingers drag to the right front and the drag distance of the right-hand side finger is smaller than that of the left-hand side finger, if the processor 120 determines that the quantity of the touch sensing signals matches a determined quantity (such as two) and determines that the drag vectors V1 and V2 have different magnitudes and turn rightward to a third direction S3 from a second direction S2, then the pilot mode 140 performs the steering pilot operation 142 on the UAV P or P′, such that the UAV P or P′ steer to moving in the third direction S3 from moving in the second direction S2. The steering angle during the steering flight of the UAV P or P′ can be determined by a predetermined steering angle or determined according to the deviation angle by which the drag vectors V1 and V2 are deviated from the second direction S2. Meanwhile, the background frame of the user interface can be concurrently adjusted along with the yaw angle by which the UAV P or P′ tilt to the right to simulate the real steering flight.

Refer to FIG. 3C. When the user's two fingers drag to the left front and the drag distance of the right-hand side finger is larger than that of the left-hand side finger, the processor 120 determines that the quantity of the touch sensing signals matches a determined quantity (such as two) and determines that the drag vectors V1 and V2 have different magnitudes and turn leftward to a third direction S3 from a second direction S2, then the pilot mode 140 performs the steering pilot operation 142 on the UAV P or P′, and the UAV P or P′ steer to moving in the third direction S3 from moving in the second direction S2. The steering angle during the steering flight of the UAV P or P′ can be determined by a predetermined steering angle or determined according to the deviation angle by which the drag vectors V1 and V2 are deviated from the second direction S2. Meanwhile, the background frame can be concurrently adjusted along with the yaw angle by which the UAV P or P′ tilt to the left to simulate the real steering flight. Also, the steering angle can be determined by the flight path of the UAV P or P′ according to the drag trace of the user's fingers.

Refer to FIG. 3D. When the user's two fingers drag leftward and the drag distances are the same, the processor 120 determines that the quantity of the touch sensing signals matches a determined quantity (such as two) and determines that the drag vectors V1 and V2 have substantially the same magnitudes and point orthogonal to a predetermined fourth direction S4, then the pilot mode 140 controls the UAV P′ to perform the lateral pilot operation 143 and controls the UAV P′ to move in a fifth direction S5 orthogonal to the predetermined fourth direction S4 according to the drag direction of the drag vectors. Meanwhile, the background frame can be concurrently adjusted along with the roll angle by which the UAV P′ tilt to the left to simulate the real steering flight. Although the drag vectors V1 and V2 may have tiny errors due to manual operation, the UAV can be regarded as performing the lateral pilot operation 143 as long as the two drag vectors are still determined as two substantially the same drag vectors.

Refer to FIG. 3E. When the user's two fingers drag rightward and the drag distances are the same, the processor 120 determines that the quantity of the touch sensing signals matches a determined quantity (such as two) and determines that the drag vectors V1 and V2 have substantially the same magnitudes and point orthogonal to a predetermined fourth direction S4, then the application program 130 performs the lateral pilot operation 143 on the UAV P′ and controls the UAV P′ to move in the fifth direction S5 orthogonal to the predetermined fourth direction S4 according to the drag direction of the drag vectors. Meanwhile, the background frame can be concurrently adjusted along with the roll angle by which the UAV P′ flies to the right to simulate the real steering flight. Although the drag vectors V1 and V2 may have tiny errors due to manual operation, the UAVs can be regarded as performing the lateral pilot operation 143 as long as the two drag vectors are still determined as two substantially the same drag vectors. Since the aircrafts such as the UAV P using jet engine propulsion does not support the lateral pilot operation 143, the lateral pilot operation 143 is regarded as being unavailable.

Furthermore, the backward pilot operation 144 can be performed on the multi-wing vertical lift UAV P′, which is capable of controlling the forward direction and the flight altitude of the aircraft and capable of changing the flight direction by adjusting the motor and transmission of individual wing. Refer to FIG. 3F. When the user's two fingers drag backward at the same time and the drag distances are the same, the processor 120 determines that the quantity of the touch sensing signals matches a determined quantity (such as two) and determines that the drag vectors V1 and V2 have substantially the same magnitudes and point to a seven direction S7 opposite to a predetermined sixth direction S6, then the pilot mode 140 performs the backward pilot operation 144 on the UAV P′, such that the UAV P′ move in a seventh direction S7 opposite to the predetermined sixth direction S6. Since the aircrafts such as the UAV P using jet engine propulsion does not support the backward pilot operation 144, the backward pilot operation 144 is regarded as being unavailable.

The above disclosure shows that the user can change the flight direction of UAV by changing the drag direction of fingers. The flight task is performed only when the fingers are placed on the touch panel. During the flight task, once the fingers are lifted from the touch panel, the touch sensing signals will no more be generated, the flight task will immediately terminate and the UAV will maintain at a fixed position in the air. The UAV is easy to operate according to the above disclosure and provides intuitive experience of flight to the user.

### Second Embodiment

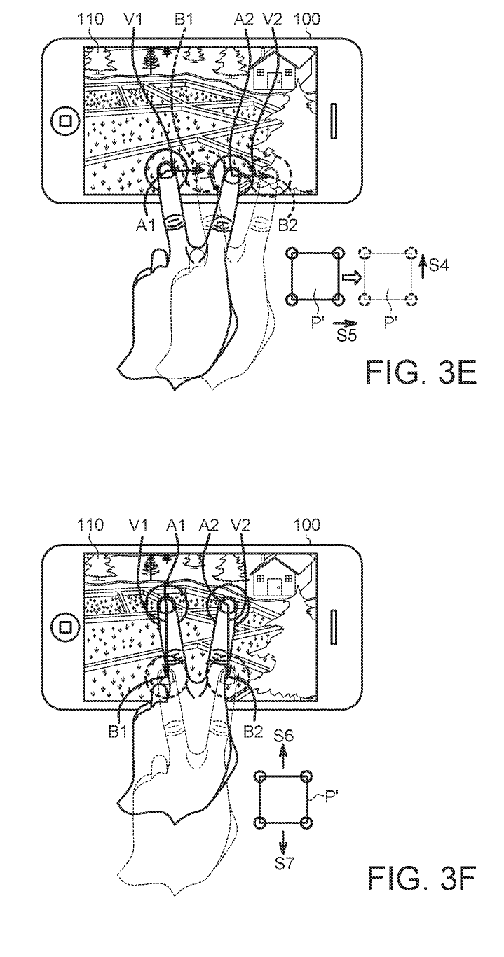

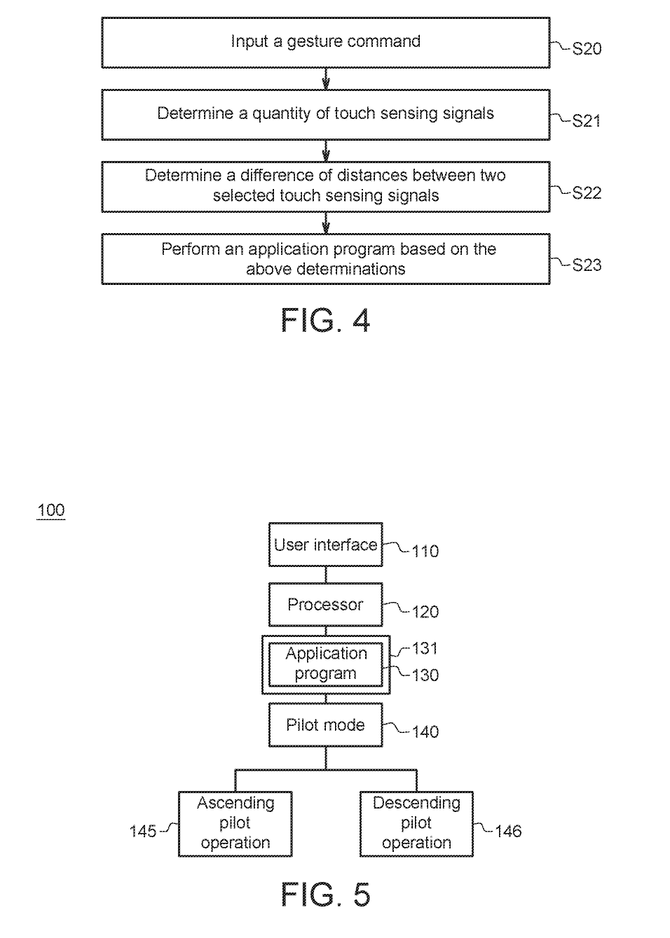

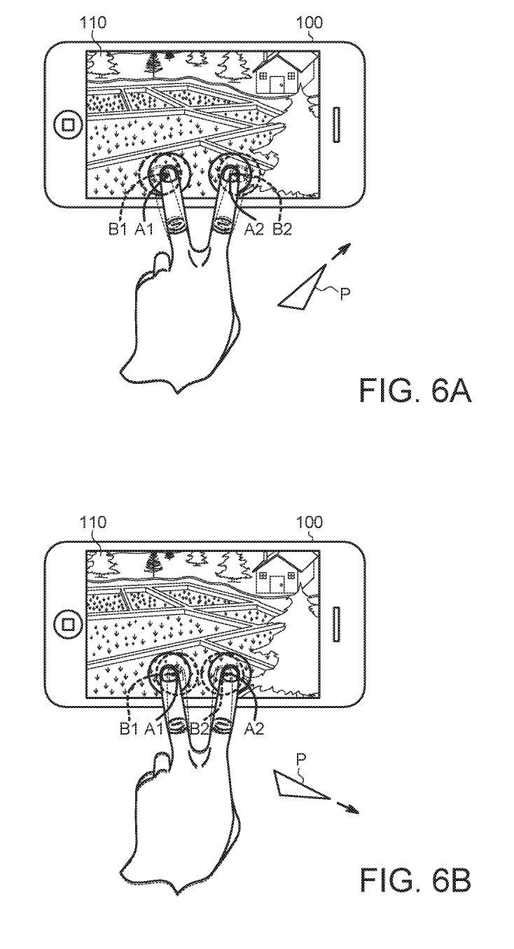

Refer to FIG. 4 to FIGS. 6A-6B. FIG. 4 is a flowchart of a touch display method according to an embodiment of the present invention. FIG. 5 is a tree diagram of a touch display device 100. FIGS. 6A-6B are operation diagrams of the touch display device 100 for executing the flowchart of FIG. 4. The touch display method includes following steps S20˜S23. In step S20, a gesture command is inputted. In step S21, a quantity of touch sensing signals is determined. In step S22, a difference of distances between two selected touch sensing signals is determined. In step S23, an application program is performed based on the above determinations.

Each step of the touch display method of FIG. 4 is exemplified through the simulated flight of UAV P or P′ as indicated in FIGS. 6A-6B. In the present embodiment, the touch display device 100 includes a processor 120 and a memory 131 storing an application program 130. Based on the gesture command inputted by the user, the application program 130 may perform an operation, such as generating a virtual object on the user interface 110, and control the virtual object in a pilot mode or a settings mode.

In step S20, when the user inputs a gesture command to perform a touch operation, the user interface 110 senses a plurality of pressing positions touched by the user's fingers (to measure a quantity of fingers or form a drag trace), a pressing time and a drag direction to generate a plurality of touch sensing signals and a plurality of drag signals. The quantity of fingers touching the panel is exemplified by two, and each finger generates a prompt ring on a touching position for recognition. Furthermore, an operation position can be used as a trigger point of an operation if the fingers' pressing time at the same point is larger than a predetermined value. Besides, the processor 120 obtains the change in finger intervals (the distance between two touch start positions A1 and A2 and the distance between two touch end positions B1 and B2) by calculating a relative distance from the touch start positions A1 and A2 to the touch end positions B1 and B2 for each drag signal.

In step S21, the processor 120 determines whether the quantity of touching fingers matches a predetermined quantity. Then, in step S22, the processor 120 determines whether the finger intervals change. In step S23, if the gesture command inputted by the user matches the two conditions disclosed above, the application program 130 performs an operation according to the inputted command. For example, the application program 130 performs an ascending pilot operation 145 (referring to FIG. 6A) or a descending pilot operation 146 (referring to FIG. 6B) on the UAV P or P′.

Refer to FIG. 5. The pilot mode 140 includes an ascending pilot operation 145 and a descending pilot operation 146. If the gesture command inputted by the user corresponds to one of the pilot mode 140, the application program 130 can perform a corresponding flight on a virtual object (such as the UAV P or P′) displayable on the user interface 110, and display an operation information or a function information corresponding to the virtual object on the user interface 110. Examples of the operation information include flight altitude, flight distance, flight time, destination, latitude and longitude etc.

Refer to FIG. 6A. When the user's two fingers drag outward and expand, if the processor 120 determines that the quantity of the touch sensing signals match a determined quantity (such as two), and determines that a first distance between the two firstly selected touch sensing signals (a relative distance between the touch start positions A1 and A2) is smaller than a second distance between the two secondly selected touch sensing signals (a relative distance between the touch end positions B1 and B2), then the pilot mode 140, based on the difference between the first distance and the second distance, performs the ascending pilot operation 145 on the UAV P or P′, such that the UAV P or P′ perform an ascending movement accordingly. Meanwhile, the background frame can be concurrently adjusted along with the pitch angle by which the UAV P or P′ ascend to simulate the real ascending flight.

Refer to FIG. 6B. When the user's two fingers drag inward and contract, if the processor 120 determines that the quantity of the touch sensing signals match a determined quantity (such as two), and determines that a first distance between the two firstly selected touch sensing signals (a relative distance between the touch start positions A1 and A2) is larger than a second distance between the two secondly selected touch sensing signals (a relative distance between the touch end positions B1 and B2), then the pilot mode 140 performs the descending pilot operation 146 on the UAV P or P′, such that the UAV P or P′ perform an descending movement accordingly. Meanwhile, the background frame can be concurrently adjusted along with the pitch angle by which the UAV P or P′ ascend to simulate the real descending flight.

The above disclosure shows that apart further performing the forward pilot operation 141, the steering pilot operation 142, the lateral pilot operation 143 and the backward pilot operation 144 on the UAV P based on the determination of the drag direction of fingers, the present invention, based on the determination of whether the finger intervals change, further performs the ascending pilot operation 145 or the descending pilot operation 146 on the UAV P. Therefore, the user can change the flight altitude by changing the finger intervals. The flight task is performed only when the finger is placed on the touch panel. During the flight task, once the finger is lifted from the touch panel, the touch sensing signals will no more be generated, the flight task will immediately terminate and the UAV will maintain at a fixed position in the air. The UAV is easy to operate according to the above disclosure and provides intuitive experience of flight to the user.

### Third Embodiment

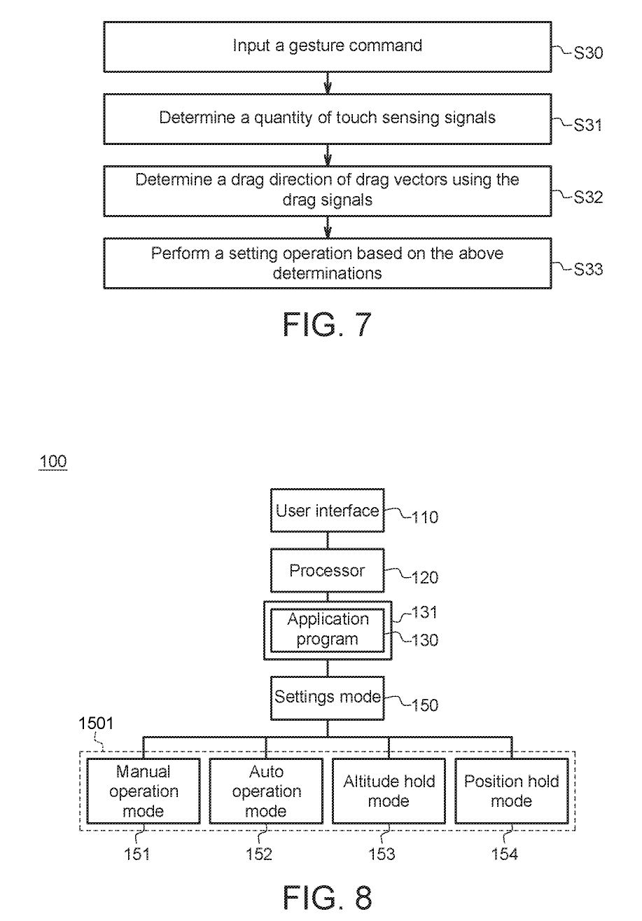

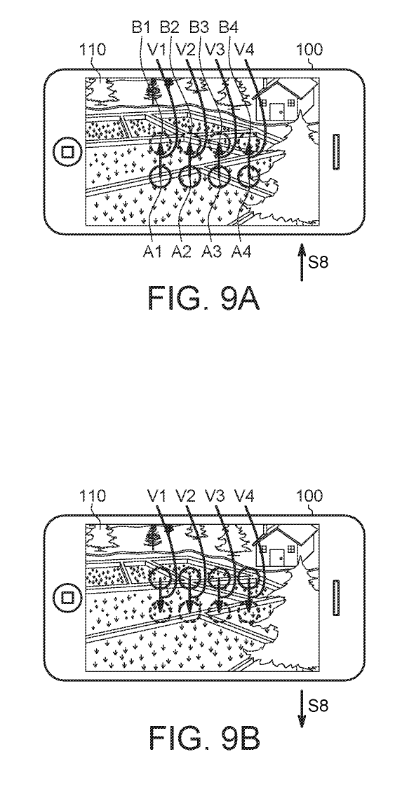

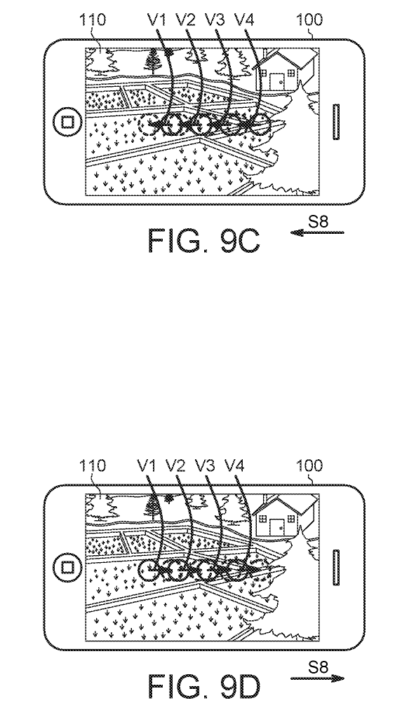

Refer to FIG. 7 to FIGS. 9A-9D. FIG. 7 is a flowchart of a touch display method according to an embodiment of the present invention. FIG. 8 is a tree diagram of a touch display device 100. FIGS. 9A-9D are operation diagrams of the touch display device 100 for executing the flowchart of FIG. 7.

The touch display method of the present embodiment includes steps S30˜S33. In step S30, a gesture command is inputted. In step S31, a quantity of touch sensing signals is determined. In step S32, a drag direction of drag vectors using the drag signals is determined. In step S33, a setting operation is performed according to the gesture command. For example, a settings mode for controlling a virtual object is performed.

Each step of the touch display method of FIG. 7 is exemplified through the simulated flight of UAV P or P′ as indicated in FIGS. 9A-9D. In the present embodiment, the touch display device 100 includes a processor 120 and a memory 131 storing an application program 130. Based on the gesture command inputted by the user, the application program 130 may perform a setting operation, such as generating a virtual object on the user interface 110, and control the virtual object in a settings mode.

In step S30, when the user inputs a gesture command to perform a touch operation, the user interface 110 senses a plurality of pressing positions touched by the user's fingers (to measure a quantity of fingers or form a drag trace), a pressing time and a drag direction to generate a plurality of touch sensing signals and a plurality of drag signals. The quantity of fingers touching the panel is exemplified by four, and each finger generates a prompt ring on a touching position for recognition. Furthermore, an operation position can be used as a trigger point of an operation if the fingers' pressing time at the same point is larger than a predetermined value. Besides, the processor 120 can generate a plurality of drag vectors V1, V2, V3 and V4 using the drag signals by calculating a relative distance and direction from the touch start positions A1, A2, A3 and A4 (referring to FIG. 9A) to the touch end positions B1, B2, B3 and B4 (referring to FIG. 9A) for each drag signal.

In step S31, the processor 120 determines whether the quantity of touching fingers matches a predetermined quantity (such as four), and, based on the determination, determines whether the quantity of the touch sensing signals matches settings mode 150. Then, in step S32, the processor 120 determines that the drag direction of fingers and, based on the determination, determines the directions of the drag vectors V1˜V4. In step S33, if the gesture command inputted by the user matches the two conditions disclosed above, the settings mode 150 activates the control mode 1501 according to the inputted gesture command. For example, a manual operation mode 151 (referring to FIG. 9A), an auto operation mode 152 (referring to FIG. 9B), an altitude hold mode 153 (referring to FIG. 9C) or a position hold mode 154 (referring to FIG. 9D) is performed on the UAV P.

Refer to FIG. 8. The control mode 1501 includes at least one of the manual operation mode 151, the auto operation mode 152, the altitude hold mode 153 and the position hold mode 154. If the gesture command inputted by the user corresponds to one of the control modes, the application program 130 can perform a setting operation on a virtual object (such as the UAV P or P′) displayable on the user interface 110, and can display a function information corresponding to the virtual object on the user interface 110. Examples of the operation information include the current control mode, current coordinate, and current altitude.

Refer to FIGS. 9A and 9B. When the user's four fingers drag upwards or downwards, if the processor 120 determines that the quantity of the touch sensing signals match a determined quantity (such as four) and the drag vectors V1˜V4 point to an eighth direction S8 (such as upwards or downwards), then the control mode 1501, such as a manual operation mode 151 (referring to FIG. 9A) or an auto operation mode 152 (referring to FIG. 9B) is activated. In the manual operation mode 151, the application program 130 controls the UAVs P or P′ in the pilot mode based on the gesture command inputted by the user. Illustratively but not restrictively, the application program 130 performs the forward pilot operation 141, the steering pilot operation 142, the lateral pilot operation 143, the backward pilot operation 144, the ascending pilot operation 145 or the descending pilot operation 146. Besides, in the auto operation mode 152, the settings mode 150 can perform a setting operation according to the inputted command, the application program 130 disables the operation relating to the pilot mode of the UAV P or P′ and performs a programmed automatic control on the movement of the UAV P or P′. That is, the user can switch back to the manual operation mode 151 again if the flight of the UAV P or P′ needs to be manually controlled.

Refer to FIGS. 9C and 9D. When the user's four fingers drag leftwards or rightwards, if the processor 120 determines that the quantity of the touch sensing signals match a determined quantity (such as four) and determines that the drag vectors V1˜V4 point to the eighth direction S8 (such as leftward or rightward), then settings mode 150 activates a control mode 1501, such as the altitude hold mode 153 (referring to FIG. 9C) or the position hold mode 154 (referring to FIG. 9D), according to the drag direction of the drag vectors. In the altitude hold mode 153, the application program 130 disables the pilot mode, and hold the current altitude and disables any vertical lift that will change the altitude of the UAV P or P′. To release the altitude holding state in the altitude hold mode 153, the user only needs to switch to the manual mode 151 or perform the altitude hold mode 153 once again.

In the position hold mode 154, the application program 130 controls the UAV P′ to maintain the coordinate of the current position and disables any movement that will change the coordinate of the current position of the UAV P′, such that the UAV P′ will maintain at a fixed position in the air. To release the suspension state in the position hold mode 154, the user only needs to switch to the manual mode 151 or perform the position hold mode 154 once again.

According to above disclosure, the present invention performs a corresponding pilot operation or corresponding setting on the UAV P or P′ according to whether the quantity of pressing fingers matches a predetermined quantity (such as two, four or other quantity) and the drag direction of the drag vectors. Therefore, by changing the quantity of pressing fingers and the drag direction of the drag vectors, the user can select corresponding pilot modes 141˜146 or switch to a settings mode 150. The UAV is such easy to operate according to the above disclosure and provides intuitive experience of flight to the user.

According to the touch display device, the method and the UAV disclosed in the above embodiments of the present invention, a gesture command is inputted through multi-finger touch and drag to avoid the problems of using a conventional hand-held remote controller. That is, the conventional operation keys and the flight parameters to adjust are too many, and the operation is too complicated. Therefore, the user can master the operation with shorter training time based on the present application, and the operation is convenient and the user can have intuitive experience of flight. Besides, the UAV can be operated through the touch display device and method disclosed above. The UAV can be controlled through the control of a virtual object without using a conventional remote control lever or flight controller to provide intuitive experience of flight to the user.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A touch display device, comprising:
a user interface for generating a plurality of touch sensing signals and a plurality of drag signals, wherein each drag signal comprises information of a touch start position and a touch end position; and
a processor configured to generate a plurality of drag vectors using the drag signals by calculating a relative distance and direction from the touch start position to the touch end position, determine if the touch sensing signals and the drag vectors match a predetermined condition, and, based on the determination, perform an application program to generate a virtual object displayable on the user interface and control the virtual object in a pilot mode or a settings mode.

2. The touch display device according to claim 1, further comprising a memory storing the application program, wherein the pilot mode is operable to control a movement of the virtual object according to a quantity of the touch sensing signals and the drag vector's direction or magnitude.

3. The touch display device according to claim 2, wherein if the quantity of the touch sensing signals matches a predetermined quantity and if the drag vectors have substantially the same magnitudes and point toward a first direction, the pilot mode controls the virtual object to move in the first direction.

4. The touch display device according to claim 2, wherein if the quantity of the touch sensing signals matches a predetermined quantity and if the drag vectors have different magnitudes and turn to a third direction from a second direction, the pilot mode controls the virtual object to steer from moving in the second direction to moving in the third direction.

5. The touch display device according to claim 2, wherein if the quantity of the touch sensing signals matches a predetermined quantity and if the drag vectors have substantially the same magnitudes and point orthogonal to a predetermined fourth direction, the pilot mode controls the virtual object to move in a fifth direction orthogonal to the predetermined fourth direction.

6. The touch display device according to claim 2, wherein if the application program determines that the quantity of the touch sensing signals matches a predetermined quantity and if the drag vectors have substantially the same magnitudes and point opposite to a predetermined sixth direction, the pilot mode controls the virtual object to move in a seventh direction opposite to the predetermined sixth direction.

7. The touch display device according to claim 2, wherein if the quantity of the touch sensing signals matches a predetermined quantity and if the drag vectors have increasing magnitudes, the pilot mode controls the virtual object to increase a movement speed.

8. The touch display device according to claim 2, wherein each touch sensing signal comprises information of a touch location on the user interface, and wherein
if the quantity of the touch sensing signals matches a predetermined quantity and a first distance between the touch locations of a two firstly selected touch sensing signals is different to a second distance between a two secondly selected touch sensing signals, the pilot mode controls the virtual object to perform an ascending or a descending movement corresponding with a magnitude of the difference between the first distance and the second distance.

9. The touch display device according to claim 2, wherein if the quantity of the touch sensing signals matches a predetermined quantity and if the touch sensing signal is not generated for a predetermined time period during the execution of the application program, the pilot mode controls the virtual object to stop movement in any direction.

10. The touch display device according to claim 2, wherein the settings mode comprises at least one control mode for controlling the virtual object, the control mode being activated if the quantity of the touch sensing signals matches a predetermined quantity and if the drag vectors point toward an eighth direction; and wherein the at least one control mode comprises at least one of:
a manual operation mode, wherein the application program controls the virtual object in the pilot mode;
an auto operation mode, wherein the application program disables pilot mode and activates a programmed automatic control of the virtual object movement;
an altitude hold mode, wherein the application program controls the virtual object to maintain a current altitude and disables any vertical movement to change the virtual object's altitude; and
a position hold mode, wherein the application program controls the virtual object to maintain a current position coordinates and disables any movement to change the virtual object's position coordinates.

11. A method for controlling a virtual object using a touch display, comprising:
generating a plurality of touch sensing signals;
generating a plurality of drag signals, each drag signal comprising information of a touch start position and a touch end position;
generating a plurality of drag vectors using the drag signals by calculating a relative distance and direction from the touch start position to the touch end position;
determining if a quantity of the touch sensing signals and the drag vector's magnitude or direction match a predetermined condition; and, based on the determination, controlling a virtual object in a pilot mode or a settings mode.

12. The method according to claim 11, further comprising: if the quantity of the touch sensing signals matches a predetermined quantity, and if the drag vectors have substantially the same magnitudes and point toward a first direction; the pilot mode controlling the virtual object to move in the first direction.

13. The method according to claim 11, further comprising: if the quantity of the touch sensing signals matches a predetermined quantity, and if the drag vectors have different magnitudes and turn to a third direction from a second direction; the pilot mode controlling the virtual object to steer from moving in the second direction to moving in the third direction.

14. The method according to claim 11, further comprising: if the quantity of the touch sensing signals matches a predetermined quantity, and if the drag vectors have substantially the same magnitudes and point orthogonal to a predetermined fourth direction; the pilot mode controlling the virtual object to move in a fifth direction orthogonal to the predetermined fourth direction.

15. The method according to claim 11, further comprising: if the quantity of the touch sensing signals matches a predetermined quantity, and if the drag vectors have substantially the same magnitudes and point opposite to a predetermined sixth direction; the pilot mode controlling the virtual object to move in a seventh direction opposite to the predetermined sixth direction.

16. The method according to claim 11, further comprising:
the pilot mode controlling the virtual object to increase a movement speed, if the quantity of the touch sensing signals matches a predetermined quantity and if the drag vectors have increasing magnitudes; and
the pilot mode controlling the virtual object to stop movement in any direction, if the quantity of the touch sensing signals matches a predetermined quantity and if the generating of the touch sensing signal is interrupted for a predetermined time period.

17. The method according to claim 11, wherein each touch sensing signal comprises information indicative of a touch location on the touch interface, the method further comprising:
if the quantity of the touch sensing signals matches a predetermined quantity, and if a first distance between the touch locations of a two firstly selected touch sensing signals is different to a second distance between a two secondly selected touch sensing signals, the pilot mode controlling the virtual object to perform an ascending or a descending movement corresponding with a magnitude of the difference between the first distance and the second distance.

18. The method according to claim 11, wherein the settings mode comprises at least one control mode for controlling the virtual object, and wherein the at least one control mode comprises at least one of a manual operation mode, an auto operation mode, an altitude hold mode and a position hold mode, the method further comprising:
activating one of the control modes according to the quantity of the touch sensing signals and the direction of the drag vectors;
controlling the virtual object in the pilot mode, if the control mode activated is the manual operation mode;
disabling pilot mode and activating a programmed automatic control of the virtual object movement, if the control mode activated is the auto operation mode;
maintaining a current altitude and disabling any vertical movement to change to the virtual object's altitude, if the control mode activated is the altitude hold mode; and
maintaining a current position coordinates and disabling any movement to change the virtual object's position coordinates, if the control mode activated is the position hold mode.

19. An unmanned aerial vehicle (UAV) controllable using the touch display device according to claim 1, wherein the control of the virtual object corresponds with the control of the UAV.

20. An unmanned aerial vehicle (UAV) controllable using the method according to claim 11, wherein the control of the virtual object corresponds with the control of the UAV.
